(19) United States
(12) Patent Application Publication
(10) Pub. No.: US 2005/0102506 A1
(43) Pub. Date: May 12, 2005

(54) Anti-piracy system

(75) Inventors: Albert Paul Pica, East Windsor, NJ (US); Jeffrey Lubin, Princeton, NJ (US); Charles August Asmuth, Princeton, NJ (US); Michael Anthony Isnardi, Plainsboro, NJ (US)

Correspondence Address: MOSER, PATTERSON & SHERIDAN, LLP;/SARNOFF CORPORATION, 595 SHREWSBURY AVENUE, SUITE 100, SHREWSBURY, NJ, 07702, US

(73) Assignee: Sarnoff Corporation

(21) Appl. No.: 10/706,518

(22) Filed: Nov. 12, 2003

(51) Int. Cl. H04L 9/00

(52) U.S. Cl. 713/165

(57) ABSTRACT

A system for reducing piracy of protected digital content. An integrated module with public and private keys sends the public key along with a request for content to a transaction manager. The transaction manager uses the public key to produce a specially encrypted content bitstream which is sent to the integrated module. The integrated module uses the private key to decrypt the specially encrypted content bitstream to produce analog information that is available for subsequent use. The decrypted content bitstream is physically protected from access. Furthermore, the analog information can be watermarked such that re-digitizing the analog information would produce a traceable watermarked copy of the content.

### BACKGROUND OF THE INVENTION

1. Field of the Invention

The present invention relates to protecting digital information. More particularly, the present invention relates to protecting digital information from unauthorized access using cryptographic techniques, physical encapsulation of digital information, and watermarking.

2. Description of the Related Art

Modern digital technology has provided numerous ways of accessing, viewing, storing, and distributing information. Indeed, it has become so easy to access, store, retrieve, and distribute information that some content owners are having difficulty taking economic advantage of their property because of content piracy. For example, the wide, but unauthorized, availability of copyrighted music on the Internet has resulted in lost sales and revenues to the copyright owners. Fear of similar problems has made some content owners reluctant to set up certain types of distribution systems for their products.

A primary reason for such fears is the relative ease with which digital information can be copied and distributed without degradation. Indeed, a digital copy of a digital copy that is transmitted over the Internet and subsequently saved can be identical to the original. In the face of widespread piracy of content, many content owners have resorted to electronic encryption to protect their property.

While electronic encryption is beneficial, it has limitations. To use the encrypted content it first must be decrypted, which means that the end user must have the ability to decrypt. For materials that are widely distributed that means that all end users must be able to decrypt the information, which means that the decryption technique must be widely distributed. Unfortunately, widely distributing a decryption technique tends to defeat the original purpose of encryption. Furthermore, after decryption any end user could digitally copy and distribute the content. For example, a bitstream of digital music can be encrypted to prevent unauthorized access. An authorized user, after decrypting the bitstream, can then simply save and redistribute the bitstream, thus rendering encryption ineffective.

Another way of rendering encryption ineffective is to hack the encrypted message and then save and distribute the content.

Therefore, a new method and apparatus for protecting distributed digital content and other information would be useful.

### SUMMARY OF THE INVENTION

In one embodiment, the principles of the present invention provide for decrypting, decoding, and converting specially encrypted, possibly watermarked, digital bitstreams into analog information that is made available for subsequent use. Typically, that analog information represents a video and/or audio composition. Locations where the decrypted bitstream exists are physically protected by encapsulation such that easy access to the decrypted bitstream is prevented. Watermarked analog information can be implemented such that re-digitizing the analog information produces a traceable watermarked copy.

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 illustrates a first system that is in accord with the principles of the present invention;

FIG. 2 illustrates a second system that is in accord with the principles of the present invention;

FIG. 3 is a generalized schematic flow diagram of the operation of the present invention; and

FIG. 4 is a schematic depiction of the overall process.

To facilitate understanding, identical reference numerals have been used to designate elements that are common in the figures.

### DETAILED DESCRIPTION OF THE PREFERRED EMBODIMENT

The present invention provides for devices, systems, and methods of discouraging piracy and protecting content. In particular, the present invention provides an integrated hardware/software/encryption anti-piracy system that is capable of uniquely encrypting content-containing bitstreams such that those bitstreams are only usable on a specified user's hardware platform. That platform physically protects unencrypted content and optionally produces robust watermarked analog signals that discourage piracy through traceability.

Encoding and decoding are terms used to designate a change in data format so that the information represented by the data is optimized for transmission and storage. Encryption is a term used to designate a transformation of data so as to make the information represented by the data unintelligible. Decryption is a term used for the process of taking encrypted information and rendering it intelligible again. Watermarking is a term used to designate a process by which audio or video content is modified to carry a hidden message.

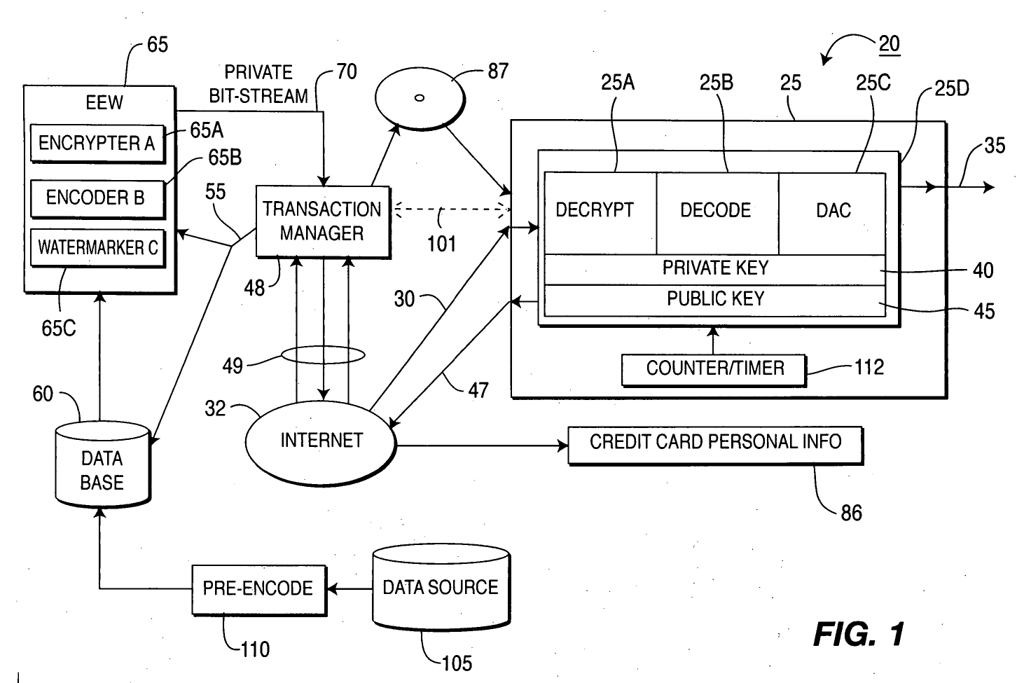

FIG. 1 illustrates a first system 20 that is in accord with the principles of the present invention. As shown, that system includes an integrated module 25 that receives encrypted bitstreams 30 over a network, e.g., the Internet 32 and that outputs analog information 35, which is optionally watermarked, for subsequent use. The integrated module 25 has various instantiations, including but not limited to, a complete set-top box, a PC plug-in device, a PC board, a stand-alone Internet appliance, or a DVD system. The analog information 35 might include copyrighted audio and/or video content.

To produce the analog information 35 the integrated module 25 includes a decrypter 25A that performs decryption, a decoder 25B that performs decoding, and a DAC (digital-to-analog) converter 25C that converts decoded information into analog. The integrated module 25 is fabricated such that intelligible digital information is physically encapsulated by an encapsulant 25D so that intelligible digital information is not easily made available outside of the integrated module 25. Encapsulation includes physically protecting an individual chip, device, module, or the entire integrated module such that attempts to gain access destroys the information stored in the module. Physically encapsulating the intelligible digital information acts as a strong deterrent to digital piracy.

The integrated module 25 stores a private key 40 and an associated public key 45. Those keys are important for encrypting and decrypting the received encrypted bitstreams 30. The private key 40 is embedded within the integrated module 25 so as to be inaccessible to anyone, including the owner of the integrated module 25. During a transaction (e.g., a request for video content) a user sends a content request 47 that includes the public key 45 over the Internet 32 to a transaction manager 48. That manager is bi-directionally connected to the Internet 32 by a communication link 49.

The transaction manager 48 responds to the content request by sending the public key 45 and a request 55 for the specified content to an EEW 65 (Encrypter 65A, Encoder 65B, and Watermarker 65C). Of course, it is possible that the transaction manager 48 and the EEW 65 are the same entity. The specified content is stored in a storage repository, e.g. a database 60, in at least a partially encoded format (such as an MPEG format). Upon receiving the request, the EEW 65 withdraws the specified content from the database 60, encodes the specified content for play by the integrated module 25, encrypts the encoded content such that it can be decoded by the private key 40, and then sends the encrypted specified content to the transaction manager 48 as a private bitstream output 70. That output is then supplied to the integrated module 25 by the transaction manager 48 via the communication link 49 and the Internet 32. Alternatively, the output 70 could be provided in other ways, such as being pressed into a DVD or CD-ROM.

As discussed subsequently, the EEW 65 can also optionally watermark the content. Watermarking techniques are taught in numerous documents, reference U.S. Patent Application Publication U.S. 2003/0021439A1, “Secure Robust High-Fidelity Watermarking, and U.S. Pat. No. 6,282,299 B1, “Method and Apparatus for Video Watermarking Using Perceptual Masks,” issued Aug. 28, 2001 and U.S. Pat. No. 6,266,430 B1, “Audio or Video Steganography,” issued on Jul. 24, 2001. Those references are hereby incorporated by reference.

The public key 45 and the private key 40 are mathematically linked such the EEW 65 may use the public key 45 to encrypt the specified content so that it can only be decrypted using the private key 40.

Alternatively, the EEW 65 or the transaction manager 48 might have a database that maps users to their public keys 45. For example, the public key information might be linked to a particular user when that user obtains the integrated module 25, or when the user registers the integrated module 25 with the transaction manager 48. In this embodiment, there is no need for the user to send the public key 45. For example, FIG. 1 includes a dashed line 101 that represents a user bypassing the Internet and directly dealing with the transaction manager 48, such may occur at a kiosk or at a local DVD outlet. In such applications, a user might supply the transaction manager 48 with the user's public key that could be embedded in a physical key tag or key card that would enable encryption the information such that only the user's private key 40 can decrypt the information. Thus, in all embodiments all information about the private key 40 is fully protected and the output 70 can only be decrypted using the private key 40 within a specific integrated module 25.

FIG. 1 illustrates various embellishments on the system 20. For example, the transaction manager 48 might obtain credit card and/or personal information from a remote database 86, possibly over the Internet. Then, a remote entity 87, such as a credit card company or a data collection system, might be informed about the transaction manager 48 supplying content to the integrated module 25. In turn, that remote entity 87 might contact the user, possibly for billing or to inform the user about the availability of similar or complementary services.

While the foregoing has broadly described the content as being encoded, in practice there are numerous encoding techniques. However, encoding and decoding content are often difficult tasks to perform. After the Transaction Manager 48 communicates the user's content request and public key information to the EEW 65, the content is either found in the database 60 or can be accessed from a data source 105. Because of the massive amounts of data in some content, such as a DVD movie or audio disk, simply accessing content can be time consuming. Therefore, to speed up the overall process it is helpful to have the content in a “pre-encoded” format. This is schematically; depicted by the pre-encoder 110. Pre-encoding (e.g., to the level of motion estimation, transform coefficients format etc.) is very computationally efficient given that a particular content (e.g., a movie) might be accessed by tens of thousands of users. By making that content available pre-encoded, massive amounts of computational power is saved.

Because of the advantages of pre-encoding, the system 20 implements two different encoding stages, and a single decoding operation within the integrated module 25. The first encoding stage is performed by the Pre-encode 110. Ideally, pre-encoding is performed on the (video/audio) content in such a way as to reduce the amount of unique encoding computation that must be performed. For example, motion estimation and computation of transform coefficients (e.g., DCT and/or wavelet) can be done during pre-encoding.

The second encoder stage is performed in the EEW 65, and is labeled “individualized encode.” It is possible to implement a special encoding scheme based on the public key 45 and/or on the integrated module 25 itself. For example, the I-frames of an MPEG-like formatted content could be jumbled such that the time sequence of I-frames could be difficult or impossible to determine using normal decoding equipment, but in a manner that is readily understood by the integrated module 25. Another encoding technique could include permutations of the order and/or type of syntax elements in an encoded bitstream. Modifications can include, for example, variations of transform type (e.g., wavelet or DCT), variations in the order of transmitted coefficients, and modifications of a code table for variable length coding.

When encrypting, for computational efficiency the entire encoded content bitstream does not necessarily need to be encrypted. Decoding instructions for each short segment of the bitstream can be encrypted and sent along with the encoded bitstream itself. Thus, only the decoding information itself would have to be encrypted and decrypted.

In addition to the standard encoding operations needed to construct a bitstream (e.g., rate-control, quantization, VLC), this stage can include watermark insertion in the transform domain. Such a watermark may include details of the transaction, such as time, date, identification of the transaction, and so on, as well as the user's identification information. That information can subsequently be used to track the user if the user supplies watermarked information to any unauthorized person.

In any event, the output 70 from the EEW 65 is specially encrypted such that decryption requires the private key 40 in the integrated module 25. The result is a private bitstream, which can be used only by one user but that can be transmitted in numerous ways, such as by being sent over the Internet or by pressing into a DVD. Once received, the private bitstream is, as previously described, decrypted using the private key 40. The decrypted signal is then decoded (possibly based on special decoding instructions decrypted using the private key 40) and converted to an analog signal stream by DAC conversion.

The encrypted bitstream can include play instructions such that after decryption by the private key 40 the play instructions can control a counter/timer 112. The counter/timer 112 can then limit content playing only within a specific time window or windows or only for a specified number of plays.

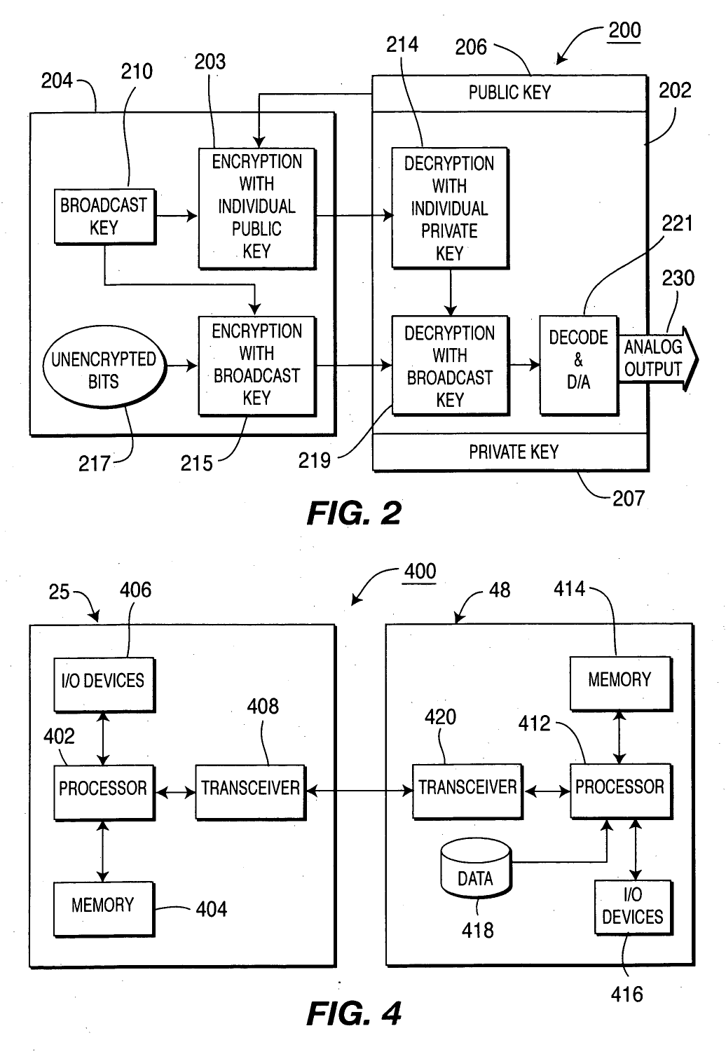

In some applications, unique encoding and encryption of each bitstream for each user is not used. In such cases at least two process variations exist. In one, pre-encoding and individualized encoding are not used and one can directly encrypt some or all of the original bitstream with the public key. The other process is a “broadcast” variation of the subject invention. FIG. 2 illustrates a broadcast system 200 of the subject invention.

The broadcast system 200 includes a user system 202 and a manager 204. When the user system 202 requests content the user system 202 sends a public key 206 to the manager 204. The manager 204 includes an encrypter 203 that encrypts a broadcast key 210 using the identified public key 206. The encrypted broadcast key 210 is then sent to the user system 202, where it is applied to an integrated module 214. The integrated module 214 includes a key decrypter that decrypts the broadcast key using the private key 206.

The manager 204 also includes an encrypter 215 that encrypts the unencrypted bits 217 of broadcast content using the broadcast key 210 and then sends the encrypted broadcast content to the user system 202. The integrated module 214 includes a broadcast decrypter 219 that decrypts the encrypted content using the broadcast key 210. After decrypting, a decode and DAC 221 converts the requested content in analog output 230. The content bitstream can be encrypted using broadcast keys that can change from one content item to another, or even within the length of the content.

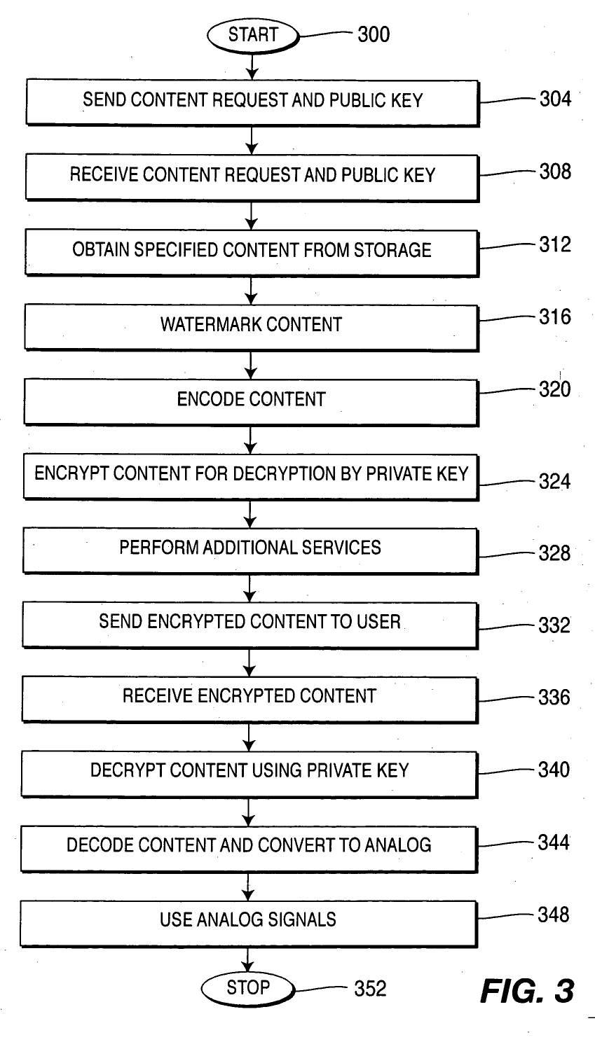

FIG. 3 illustrates a generalized flow diagram of system operation. The system starts at step 300 and proceeds at step 304 by a user sending a content request to a manager (which will be assumed to be a combination of transaction manager/EEW and/or a broadcast manager). While performing step 304 the user provides a public key, either electronically or by way of a key tag, key card, database, or some other technique of transferring information to the manager.

At step 308 the manager receives the content request and public key, and at step 312 the manager obtains content, such as from storage. At step 316 a watermark can optionally be inserted, at step 320 the content is optionally encoded, and at step 324 the content is encrypted. In some variations, such as the broadcast variation described above, the content might already be watermarked and/or encoded, and/or encrypted. The encrypting step 324 might be performed in numerous ways as previously described. Furthermore, step 324 is meant to include the use of encrypting a broadcast key for decrypting by a private key.

After encrypting, at step 328 the manager can perform additional services, such as billing or inserting commercials. Then, at step 332 the encrypted content is sent to the user. At step 336 the user receives the encrypted content, and at step 340 the user decrypts the content using his private key. Then, at step 344 the content is decoded and converted to analog signals, at step 348 the analog signals are played (used), and at step 352 the system stops.

The foregoing system can be based on preprogrammed instructions that co-ordinate activities as multiple sites. For example, FIG. 4 illustrates a generalized system 400 configuration of the present invention. That system 400 includes a transaction manager 48 and an integrated module 25. The integrated module 25 can be generalized to include a processor 402, a memory 404, and a set of I/O devices 406, which includes a transceiver 408. The memory 404 includes software program instructions for operating the integrated module 25 as described above and as shown in FIG. 3. The present invention as described with respect to the integrated module 25 can be implemented using instructions stored on a computer readable medium when those instructions are retrieved and executed by a processor.

The transaction manager 48 can be generalized to include a processor 412, memory 414, a set of I/O devices 416, which includes a data storage device 418 and a transceiver 420. The memory 414 includes software program instructions for enabling the transaction manager 48 to perform its tasks as described above and as shown in FIG. 3. In FIG. 4, the transaction manager 48 represents a generalized manager, which could include an encrypter and/or a broadcast station. The present invention as described with respect to the transaction manager can be implemented using instructions stored on a computer readable medium when those instructions are retrieved and executed by a processor.

Although various embodiments which incorporate the teachings of the present invention have been shown and described in detail herein, those skilled in the art can readily devise many other varied embodiments that still incorporate these teachings. Therefore, the scope of the present invention is to be determined by the claims that follow.

1. An anti-piracy method comprising:
encapsulating a private key in a hardware platform;
requesting content by providing a content request and a public key to a transaction manager;
obtaining the requested content;
encrypting the requested content such that the encrypted content can be decrypted using the private key;
providing the encrypted content to the hardware platform; and
decrypting the encrypted content using the private key to produce a decrypted digital content.

2. The method of claim 1 further including a step of encoding the requested content before encrypting.

3. The method of claim 2 further including converting the decrypted digital content into an analog signal.

4. The method of claim 3 wherein said encrypting step comprises watermarking the requested content.

5. The method of claim 4 wherein watermarking adds traceable information.

6. The method of claim 1 wherein the requested content is retrieved from memory before encrypting.

7. The method of claim 1 wherein the retrieved content is pre-encoded.

8. The method of claim 1 wherein the encrypted content includes play-limiting instructions.

9. An anti-piracy method comprising:
encapsulating a private key in a hardware platform;
requesting broadcast content and providing a content provider with a public key;
encrypting the broadcast content using a broadcast key such that it can be decrypted using the broadcast key;
encrypting the broadcast key using the public key such that the broadcast key can be decrypted using the private key;
sending the encrypted broadcast key and the encrypted broadcast content to the hardware platform;
decrypting the encrypted broadcast key within the hardware platform using the private key; and
decrypting the encrypted broadcast content using the decrypted broadcast key.

10. An anti-piracy system comprising:
an integrated module containing a public key and a private key, said integrated module for receiving encrypted content; and
a manager for receiving a specific content request and public key information, for retrieving the specific content from a storage, and for encrypting the retrieved specific content so that it can be decrypted by said private key;
wherein said integrated module and said manager inter-operatively interact.

11. The system of claim 10 wherein said integrated module and said manager inter-operatively interact using the Internet.

12. The system of claim 10 wherein the integrated module physically encapsulates the private key.

13. An anti-piracy system comprising:
an integrated module containing a public key and a private key, said integrated module for transmitting a broadcast request and the public key and for receiving content; and
a manager for receiving the broadcast request and the public key; wherein the manager includes a broadcast key and a key encrypter for encrypting the broadcast key using the public key such that the broadcast key can be decoded by the private key, wherein the manager further includes a content encrypter for encrypting encoded content using the broadcast key and for transmitting the encrypted content;
wherein the integrated module and the manager inter-operatively interconnect;
wherein the integrated module includes a key decrypter for decrypting the encrypted broadcast key;
wherein the integrated module includes a broadcast decoder for decoding the decrypted broadcast using the broadcast key; and
wherein the integrated module converts the decrypted broadcast content into an analog output.

14. A system of claim 13 wherein the key encrypter changes the encrypted broadcast key within the encrypted content.

15. An integrated module, comprising:
an embedded private key;
a public key mathematically linked to said private key;
a decrypt section for receiving and decrypting an encrypted bitstream using the private key;
a decoder for decoding the decrypted bitstream into decoded digital content;
a digital-to-analog converter for converting the decoded digital content into an analog signal; and
a public key section for sending the public key to an external receiver such that the public key becomes available for encrypting content such that the encrypted content can be decrypted using said private key;
wherein the decrypted bitstream and the decoded digital content are physically encapsulated.

16. An integrated module, comprising:
an embedded private key;
a transmitter for sending a public key that is mathematically linked to said private key;
a key decrypter for receiving and decrypting an encrypted broadcast key using the private key;
a broadcast decrypter for decrypting an encrypted broadcast bitstream into digital content using the decrypted broadcast key;
a decoder for decoding the decrypted broadcast bitstream into decoded digital content; and
a digital-to-analog converter for converting the decoded digital content into an analog signal.

17. The integrated module of claim 16 wherein the decrypted bitstream and the decoded digital content are encapsulated.

18. A system manager comprising:
an input system for receiving a content request and a public key;
a database for storing content;
a processor for retrieving specific content from the database based on the content request; and
an encryption section for encrypting the specific content based on the public key onto an output such that the encrypted content can be decrypted using the private key.

19. A broadcast manager comprising:
an input port for receiving a content request and a public key;
a key encrypter for encrypting a broadcast key based on the public key such that the broadcast key can be decrypted using an associated private key;
a broadcast content provider for providing a broadcast content;
a broadcast encrypter for encrypting the broadcast content such that the broadcast content can be decrypted using the broadcast key; and
an output port for transmitting the encrypted broadcast content and the encrypted broadcast key.

20. A content protection method comprising:
encapsulating a private key and a public key;
transmitting the public key and a content request;
receiving encrypted content in response to the transmitted public key and content request;
decrypting the received encrypted content into a bitstream using the private key;
decoding the decrypted bitstream into decoded digital content; and
converting the decoded digital content into an analog signal.

21. A content protection method comprising:
encapsulating a private key and a public key;
transmitting the public key and a content request;
receiving an encrypted broadcast key;
decrypting the encrypted broadcast key to determine the broadcast key;
receiving encrypted content;
decrypting the encrypted content using the decrypted broadcast key into decrypted digital content; and
converting the decoded digital content into an analog signal.

22. A content protection method comprising:
receiving a content request and a public key;
accessing stored content based on the content request;
encrypting the accessed content based on the received public key such that the encrypted content can be decrypted using an associated private key; and
transmitting the encrypted content.

23. A content protection method comprising:
receiving a content request and a public key;
encrypting a broadcast key based on the public key such that the broadcast key can be decrypted using an associated private key;
accessing broadcast content;
encrypting the broadcast content such that the broadcast content can be decrypted using the decrypted broadcast key; and
transmitting the encrypted broadcast content and the encrypted broadcast key.
